(19) United States
(12) Patent Application Publication
(10) Pub. No.: US 2024/0342660 A1
(43) Pub. Date: Oct. 17, 2024

(54) ELECTRONIC DEVICE FOR CONTROLLING HOLLOW-FIBER MEMBRANE FOULING REDUCTION SYSTEM, SYSTEM COMPRISING SAME, AND CONTROL METHOD

(71) Applicant: Kookmin University Industry Academy Cooperation Foundation, Seoul (KR)

(72) Inventors: Sang Ho Lee, Seoul (KR); Young Kyu Park, Goyang-si (KR); Ju Young Lee, Seoul (KR)

(21) Appl. No.: 18/757,499

(22) Filed: Jun. 28, 2024

Related U.S. Application Data
(63) Continuation of application No. PCT/KR2022/005368, filed on Apr. 13, 2022.

(30) Foreign Application Priority Data
Dec. 31, 2021 (KR) 10-2021-0194253

(51) Int. Cl. B01D 65/08; B01D 63/02; B01D 63/16; B01D 65/02; C02F 1/00; C02F 1/44

(52) U.S. Cl. CPC B01D 65/08; B01D 63/02; B01D 63/16; B01D 65/02; C02F 1/008; C02F 1/44; B01D 2315/04; B01D 2321/2058; C02F 2303/16; C02F 2303/22

(57) ABSTRACT

Proposed is an electronic device for controlling a hollow fiber membrane fouling reduction system including an exciter controller that generates an excitation signal, an exciter module that generates vibration corresponding to the excitation signal by being connected electrically to the exciter controller, and a hollow fiber membrane module that receives the vibration generated from the exciter module, the electronic device including a vibration analysis module that receives first and second vibration values for frequencies sensed respectively from the exciter module and the hollow fiber membrane module, calculates a vibration value transmission rate for each frequency based on the first and second vibration values, and calculates an optimal frequency at which the vibration value transmission rate is highest, and an optimal sound source selection module that receives feedback of the optimal frequency and selects an optimal sound source used to generate the excitation signal, based on the optimal frequency.

### TECHNICAL FIELD

The present disclosure relates to an electronic device for controlling a hollow-fiber membrane fouling reduction system, a system including the same, and a control method.

### BACKGROUND ART

A membrane filtration process using vibration was first proposed by J. Brad Culkin (1987) under the name of a vibratory shear enhanced process (VSEP), and the prototype of the VSEP was manufactured by combining a loudspeaker and a separation membrane process. Afterwards, a membrane separation process using vibration was developed by Armando et al. (1992), in which a device is constructed such that circular polymer membranes are stacked, a gasket is placed between the membranes to collect the produced water, and a vertical oscillator is installed to generate vibration of about 60 Hz.

Membrane evaporation is a process that converts raw water into pure vapor by using a vapor pressure difference generated by a temperature difference before and after a porous and hydrophobic separation membrane as a driving force, passes the pure vapor through the separation membrane, and condenses the pure vapor again to obtain filtered water.

All of the above-described processes have a common problem of membrane fouling, and continuous research and technology development are being conducted to reduce the membrane fouling. However, membrane fouling reduction technology that is able to be effectively applied to various processes such as the membrane separation process and the membrane evaporation, etc. does not yet exist.

### DOCUMENTS OF RELATED ART

### Patent Documents

(Patent Document 1) Korean Patent No. 10-2101082
(Patent Document 2) Korean Patent Application Publication No. 10-2016-0050683

### DETAILED DESCRIPTION OF THE INVENTION

### Technical Problem

Various examples of the present disclosure are intended to provide an electronic device for controlling a hollow-fiber membrane fouling reduction system, a system including the same, and a control method, in which powerful shear force caused by vibration is able to suppress membrane fouling and reduce the energy usage of the entire system.

Technical tasks to be achieved in the various examples of the present disclosure are not limited to the matters mentioned above, and other technical tasks not mentioned may be considered by those skilled in the art from the various examples of the present disclosure to be described below.

### Technical Solution

In one aspect of the present disclosure, there is provided an electronic device for controlling a hollow-fiber membrane fouling reduction system including an exciter controller that generates an excitation signal, an exciter module that generates vibration corresponding to the excitation signal by being connected electrically to the exciter controller, and a hollow-fiber membrane module that receives the vibration generated from the exciter module, the electronic device including a vibration analysis module that receives first vibration values and second vibration values for frequencies sensed respectively from the exciter module and the hollow-fiber membrane module, calculates a vibration value transmission rate for each frequency based on the first vibration values and the second vibration values, and calculates an optimal frequency at which the vibration value transmission rate is highest, and an optimal sound source selection module that receives feedback of the optimal frequency and select an optimal sound source used to generate the excitation signal among at least one sound source, based on the optimal frequency.

For example, the vibration value transmission rate may be defined as a ratio of the first vibration values to the second vibration values for frequencies.

For example, the optimal sound source selection module may calculate a difference value between an optimal vibration value corresponding to the optimal frequency among the second vibration values and an average vibration value calculated for each of the at least one sound source, and may select, as the optimal sound source, a sound source corresponding to an average vibration value at which the difference value is lowest.

For example, the electronic device may further include a sound source preprocessing module that analyzes a frequency spectrum of each of a plurality of sound sources and selects the at least one sound source among the plurality of sound sources.

For example, the sound source preprocessing module may select, as the at least one sound source, a sound source in which a ratio of a preset frequency range to the frequency spectrum is greater than or equal to a preset ratio threshold among the plurality of sound sources.

For example, the electronic device may further include a drive module that drives the hollow-fiber membrane module in one of an internal pressure mode and an external pressure mode, wherein the drive module may generate a first excitation signal generation instruction corresponding to the optimal frequency and transmit the first excitation signal generation instruction to the exciter controller in the internal pressure mode, and may generate a second excitation signal generation instruction corresponding to the optimal sound source and transmit the second excitation signal generation instruction to the exciter controller in the external pressure mode.

In another aspect of the present disclosure, a hollow-fiber membrane fouling reduction system includes an exciter controller that generates an excitation signal, an exciter module that generates vibration corresponding to the excitation signal by being connected electrically to the exciter controller, a hollow-fiber membrane module that receives the vibration generated from the exciter module, and an electronic device that controls the exciter controller and the hollow-fiber membrane module, wherein the electronic device includes a vibration analysis module that receives first vibration values and second vibration values for frequencies sensed respectively from the exciter module and the hollow-fiber membrane module, calculates a vibration value transmission rate for each frequency based on the first vibration values and the second vibration values, and calculates an optimal frequency at which the vibration value transmission rate is highest, and an optimal sound source selection module that receives feedback of the optimal frequency and selects an optimal sound source used to generate the excitation signal among at least one sound source, based on the optimal frequency.

For example, the optimal sound source selection module may calculate a difference value between an optimal vibration value corresponding to the optimal frequency among the second vibration values and an average vibration value calculated for each of the at least one sound source, and may select, as the optimal sound source, a sound source corresponding to an average vibration value at which the difference value is lowest.

For example, the electronic device may further include a sound source preprocessing module that analyzes a frequency spectrum of each of a plurality of sound sources and selects the at least one sound source among the plurality of sound sources, wherein the sound source preprocessing module may select, as the at least one sound source, a sound source in which a ratio of a preset frequency range to the frequency spectrum is greater than or equal to a preset ratio threshold among the plurality of sound sources.

For example, the electronic device may further include a drive module that drives the hollow-fiber membrane module in one of an internal pressure mode and an external pressure mode, wherein the drive module may generate a first excitation signal generation instruction corresponding to the optimal frequency and transmit the first excitation signal generation instruction to the exciter controller in the internal pressure mode, and may generate a second excitation signal generation instruction corresponding to the optimal sound source and transmit the second excitation signal generation instruction to the exciter controller in the external pressure mode.

For example, the system may further include an amplification module that amplifies the excitation signal and transmits the excitation signal to the exciter module.

For example, the exciter module may further include an exciter that receives the excitation signal and generates vibration corresponding to the excitation signal, and a first acceleration sensor that is electrically connected to the exciter and senses the first vibration values from the vibration of the exciter, wherein the hollow-fiber membrane module may further include a hollow-fiber membrane that receives the vibration generated from the exciter and filter raw water based on the vibration, and a second acceleration sensor that is electrically connected to the hollow-fiber membrane and senses the second vibration values from the vibration of the hollow-fiber membrane.

In another aspect of the present disclosure, there is provided a method for controlling a hollow-fiber membrane fouling reduction system performed by an electronic device, the method including receiving first vibration values and second vibration values for frequencies sensed respectively from an exciter module and a hollow-fiber membrane module, calculating a vibration value transmission rate for each frequency based on the first vibration values and the second vibration values, and calculating an optimal frequency at which the vibration value transmission rate is highest, and receiving feedback of the optimal frequency, and selecting an optimal sound source used to generate the excitation signal among at least one sound source based on the optimal frequency.

For example, the selecting of the optimal sound source may further include calculating a difference value between an optimal vibration value corresponding to the optimal frequency among the second vibration values and an average vibration value calculated for each of the at least one sound source, and selecting, as the optimal sound source, a sound source corresponding to an average vibration value at which the difference value is lowest.

For example, the method may further include calculating a ratio of a preset frequency range to a frequency spectrum for each of a plurality of sound sources, and selecting, as the at least one sound source, a sound source in which the ratio is greater than or equal to a preset ratio threshold among the plurality of sound sources.

The various examples of the present disclosure described above are only some of the preferred examples of the present disclosure, and various examples reflecting the technical features of the various examples of the present disclosure may be derived and understood based on detailed description to be described in detail below by those skilled in the art.

### Advantageous Effects of the Invention

According to various examples of the present disclosure, the following effects are achieved.

According to various examples of the present disclosure, it is possible to provide an electronic device for controlling a hollow-fiber membrane fouling reduction system, a system including the same, and a control method, in which powerful shear force caused by vibration is able to suppress membrane fouling and reduce energy usage of the entire system.

Effects that are able to be obtained from various examples of the present disclosure are not limited to the effects mentioned above, and other effects not mentioned may be clearly derived and understood by those skilled in the art based on the detailed description below.

### DESCRIPTION OF THE DRAWINGS

The drawings attached below are intended to aid understanding of various examples of the present disclosure and provide various examples of the present disclosure along with detailed descriptions. However, the technical features of various examples of the present disclosure are not limited to specific drawings, and the features disclosed in each drawing may be combined to form a new embodiment. Reference numerals in each drawing refer to structural elements.

FIG. 1 illustrates a hollow-fiber membrane fouling reduction system according to an example of the present disclosure.

FIG. 2 illustrates the process of the hollow-fiber membrane fouling reduction system according to an example of the present disclosure.

FIG. 3 is the functional block diagram of an electronic device according to an example of the present disclosure.

FIG. 4 illustrates the preprocessing standard of a sound source preprocessing module.

FIG. 5 is a flowchart of a method for controlling a hollow-fiber membrane fouling reduction system according to an example of the present disclosure.

FIG. 6 is a flowchart of a sound source preprocessing method according to an example of the present disclosure.

FIG. 7 is a flowchart of an optimal sound source selection method according to an example of the present disclosure.

FIG. 8 is a flowchart of a hollow-fiber membrane fouling reduction method according to an example of the present disclosure.

FIGS. 9A and 9B illustrate flux results for VCFs according to experimental examples of the present disclosure.

FIGS. 10A and 10B illustrate flux results for VCFs according to another experimental example of the present disclosure.

FIG. 11 illustrates the power consumption of vibration generation according to an experimental embodiment of the present disclosure.

### BEST MODE

Hereinafter, implementations according to the present disclosure will be described in detail with reference to the attached drawings. Detailed description to be disclosed below along with the accompanying drawings is intended to describe illustrative implementations of the present disclosure and is not intended to represent an only implementation form in which the present disclosure may be implemented. The detailed description below includes specific details to provide the complete understanding of the present disclosure. However, one skilled in the art will understand that the present disclosure may be practiced without these specific details.

Various examples according to the concept of the present disclosure may be variously changed and may take various forms, so various examples are illustrated in the drawings and are described in detail in the present disclosure. However, this is not intended to limit the various examples according to the concept of the present disclosure to specific disclosure forms, and includes changes, equivalents, or substitutes included in the idea and technical scope of the present disclosure.

Terms such as first or second may be used to describe various components, but the components should not be limited by the terms. The terms are used solely for the purpose of distinguishing one component from another, and for example, a first component may be named a second component without departing from the scope of the claims according to the concept of the present disclosure, and similarly, the second component may also be named the first component.

In various examples of this disclosure, “/” and “,” should be interpreted as indicating “and/or.” For example, “A/B” may mean “A and/or B.” Furthermore, “A, B” may mean “A and/or B.” Furthermore, “A/B/C” may mean “at least one of A, B and/or C.” Furthermore, “A, B, C” may mean “at least one of A, B and/or C.”

In various examples of this disclosure, “or” should be interpreted as indicating “and/or.” For example, “A or B” may include “only A,” “only B,” and/or “both A and B.” In other words, “or” should be interpreted as indicating “additionally or alternatively.”

Hereinafter, various examples of an electronic device for controlling a hollow-fiber membrane fouling reduction system, a system including the same, and a control method are disclosed. Before describing various examples of the present disclosure, some terms used in the present disclosure are defined as follows.
Hollow-fiber membrane: a separation membrane made of thin fibers with a plurality of small pores on surfaces thereof and central empty space. Used in filtering various raw water such as sterile water, drinking water, river water, industrial water and swimming pool water, or in precision filtration fields such as ultrapure water production, etc.
An internal pressure type: one of the filtration methods of a hollow-fiber membrane, in which raw water flows from the inside of the membrane to the outside.

An external pressure type: one of the filtration methods of a hollow-fiber membrane, in which raw water flows from the outside of the membrane to the inside thereof.
Flux: a flow rate of a hollow-fiber membrane
MD: an abbreviation for membrane distillation. A membrane distillation method.
VCF: an abbreviation for volume of a concentration factor. VCF is defined as the ratio of the initial amount of raw water supply to difference between the initial amount of the raw water supply and the production amount of cumulative permeated water.

### Hollow-Fiber Membrane Fouling Reduction System

The hollow-fiber membrane fouling reduction system according to an example of the present disclosure includes various configurations to reduce membrane fouling occurring in a hollow-fiber membrane.

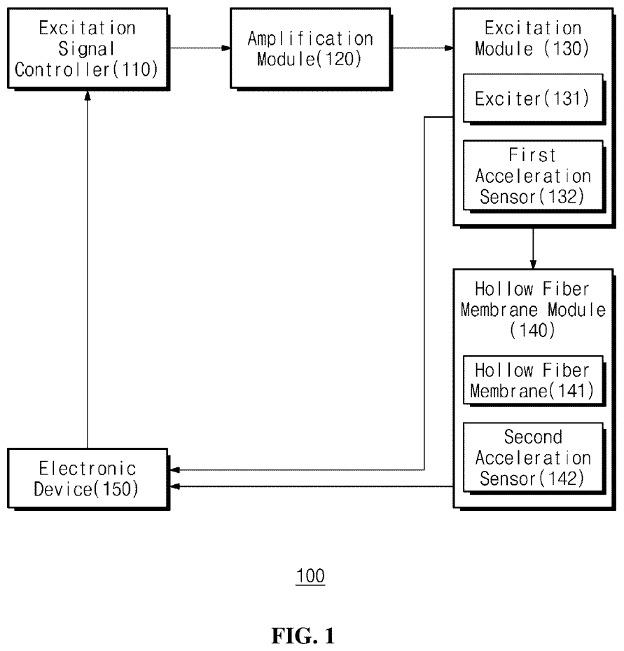

FIG. 1 illustrates a hollow-fiber membrane fouling reduction system according to an example of the present disclosure.

Referring to FIG. 1, a hollow-fiber membrane fouling reduction system 100 according to an example of the present disclosure includes an exciter controller 110, an amplification module 120, an exciter module 130, a hollow-fiber membrane module 140, and an electronic device 150.

The exciter controller 110 generates an excitation signal and transmits the excitation signal to the amplification module 120. The exciter controller 110 may have an input/output interface and/or a transceiver, and may generate the excitation signal with various frequencies based on an input from the input/output interface and/or the transceiver. For example, the excitation signal may include periodic signals such as sine waves, directional waves, triangle waves, and sawtooth waves, and aperiodic signals such as sound sources.

The exciter controller 110 may convert a digital signal from the input/output interface and/or the transceiver into an excitation signal, which is an analog signal.

The amplification module 120 receives the excitation signal from the exciter controller 110, amplifies the excitation signal, and transmits the amplified excitation signal to the exciter module 130.

The exciter module 130 is electrically connected to the exciter controller 110 and generates vibration corresponding to the excitation signal. The exciter module 130 may include an exciter 131 that receives the excitation signal and generates vibration corresponding to the excitation signal, and a first acceleration sensor 132 which is electrically connected to the exciter 131 and senses a first vibration value from the vibration of the exciter 131.

The hollow-fiber membrane module 140 receives vibration generated from the exciter module 130. The hollow-fiber membrane module 140 includes a hollow-fiber membrane 141 that receives vibration generated from the exciter 131 and filters raw water based on the vibration, and a second acceleration sensor 142 that is electrically connected to the hollow-fiber membrane 141 and senses a second vibration value from the vibration of the hollow-fiber membrane 141.

The first vibration value and the second vibration value sensed from the exciter module 130 and the hollow-fiber membrane module 140 described above may be, for example, in units of g (here, g=9.80665 m/s²). Alternatively, the first vibration value and the second vibration value may be root mean square (RMS) values.

The electronic device 150 controls the hollow-fiber membrane fouling reduction system 100. For example, the electronic device 150 may control the exciter controller 110 and the hollow-fiber membrane module 140 included in the hollow-fiber membrane fouling reduction system 100.

The electronic device 150 receives the first vibration value and the second vibration value described above, and performs a vibration analysis action for each of the exciter module 130 and the hollow-fiber membrane module 140 based on the first vibration value and the second vibration value which are received. Here, the vibration analysis action may correspond to calculating a vibration value transmission rate for each frequency based on the first vibration value and the second vibration value, and calculating an optimal frequency at which the vibration value transmission rate is highest.

The electronic device 150 performs the vibration analysis action and then selects an optimal sound source to be used to generate the excitation signal. In particular, result values fed back by performing the vibration analysis action may be used to select the optimal sound source.

Below, the overall process of the hollow-fiber membrane fouling reduction system 100 described above will be described.

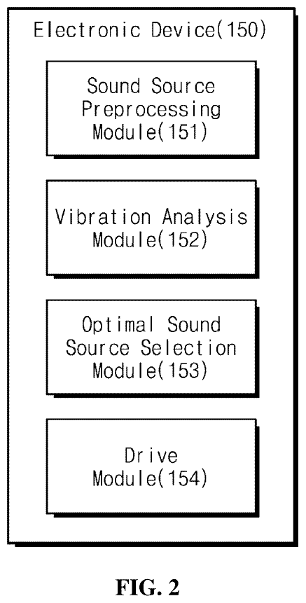

FIG. 2 illustrates the process of the hollow-fiber membrane fouling reduction system according to an example of the present disclosure.

Referring to FIG. 2, the exciter controller 110 generates excitation signals 210 for various frequencies. The excitation signals 210 for frequencies may be amplified through the amplification module 120. Each of the excitation signals 210 for frequencies may correspond to any one of a plurality of frequencies. Each of the excitation signals 210 for frequencies may correspond to one analog signal with one frequency, rather than a combination of a plurality of analog signals.

The excitation signals 210 for frequencies are transmitted to the exciter 131, and the exciter 131 generates vibration for each frequency based on converting the electrical energy of each of the excitation signals 210 for frequencies into vibration energy. The vibration for each frequency is applied to the hollow-fiber membrane module 140. Due to the application of the vibration for each frequency, vibration generated from the exciter 131 and vibration generated from the hollow-fiber membrane module 140 are respectively sensed as a first vibration value and a second vibration value 220 by the first acceleration sensor 132 and the second acceleration sensor 142.

The electronic device 150 performs the vibration analysis action on the first vibration value and the second vibration value 220, and calculates a vibration value transmission rate 230 for each frequency according to the vibration analysis action.

The electronic device 150 calculates, as an optimal frequency 231, one frequency, at which the vibration value transmission rate 230 for each frequency is highest, among a plurality of frequencies.

The electronic device 150 selects an optimal sound source used to generate an excitation signal among at least one sound source 240 based on the calculated optimal frequency 231.

The electronic device 150 may transmit the optimal sound source to the exciter controller 110, or an input corresponding to the optimal sound source may be input to the exciter controller 110 from a user through the input/output interface.

The exciter controller 110 generates the excitation signal corresponding to the optimal sound source and finally transmits the excitation signal to the hollow-fiber membrane module 140, so that the membrane fouling of the hollow-fiber membrane module 140 may be reduced based on the excitation signal corresponding to the optimal sound source. Here, the correspondence of the excitation signal to the optimal sound source may mean that the excitation signal is a signal with the same frequency spectrum as the optimal sound source.

### Electronic Device

Hereinafter, the electronic device 150 included in the hollow-fiber membrane fouling reduction system 100 of the present disclosure described above will be described. The electronic device 150 according to an example of the present disclosure may include various functional modules. Functional units included in the electronic device 150 disclosed below may be implemented as hardware including a transceiver, a memory, and a processor, software for implementing instructions, or a combination of hardware and software.

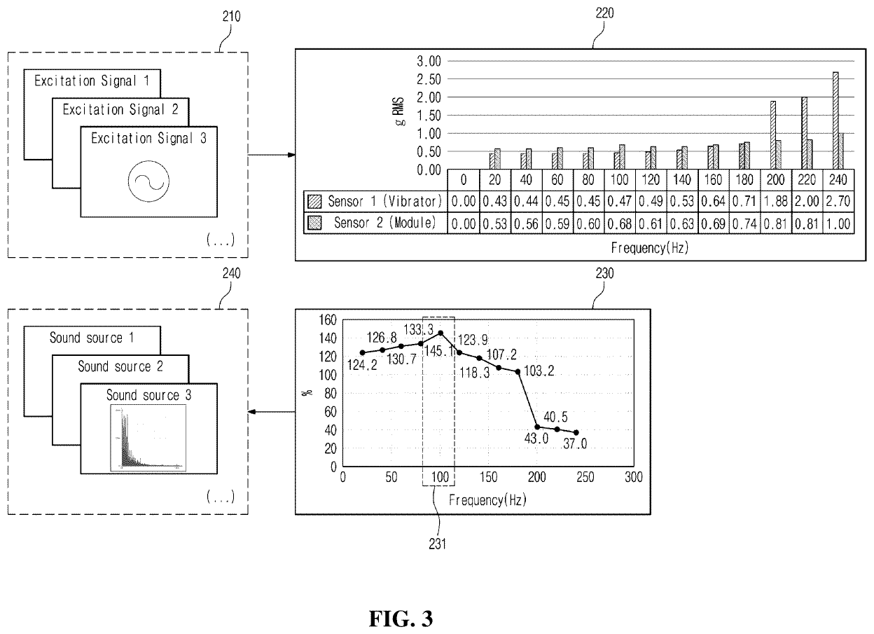

FIG. 3 is the functional block diagram of an electronic device according to an example of the present disclosure.

Referring to FIG. 3, the electronic device 150 according to an example of the present disclosure includes a sound source preprocessing module 151, a vibration analysis module 152, an optimal sound source selection module 153, and a drive module 154.

The sound source preprocessing module 151 preprocesses a plurality of sound sources prestored in a memory. The sound source preprocessing module 151 analyzes the frequency spectrum of each of the plurality of sound sources and selects at least one sound source among the plurality of sound sources.

For example, the sound source preprocessing module 151 may select, as the at least one sound source, a sound source in which the ratio of a preset frequency range to the frequency spectrum is greater than or equal to a preset ratio threshold among the plurality of sound sources. That is, the sound source preprocessing module 151 may primarily select sound sources, which are able to cause more effective vibration in reducing membrane fouling, among various sound sources.

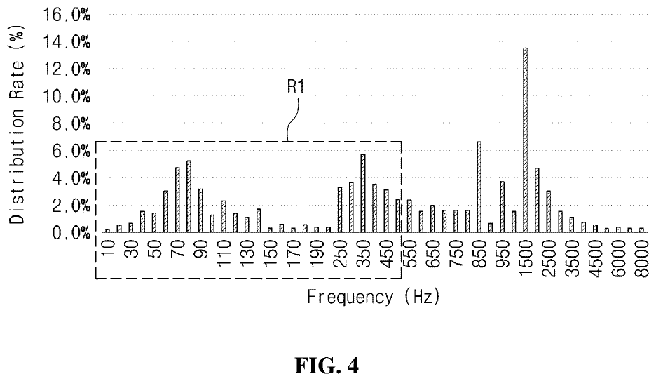

FIG. 4 illustrates the preprocessing standard of a sound source preprocessing module.

Referring to FIG. 4, for example, when a preset frequency range R1 is set to be 0 Hz to 500 Hz and the preset ratio threshold is set to be 50%, the sound source preprocessing module 151 analyzes the frequency spectrum of each of the plurality of sound sources, and selects, as the at least one sound source, only sound sources in which the ratio of the frequency range corresponding to 0 Hz to 500 Hz to a total frequency range is 50% or less.

The selected at least one sound source may be included in a selection pool of the optimal sound source selection.

Referring back to FIG. 3, the vibration analysis module 152 receives the first vibration value and the second vibration value for each frequency sensed respectively from the exciter module 130 and the hollow-fiber membrane module 140, calculates the vibration value transmission rate for each frequency based on the first vibration value and the second vibration value, and calculates an optimal frequency at which the vibration value transmission rate is highest.

As described above, the first vibration value and the second vibration value are values measured respectively from excitation signals for frequencies.

The vibration value transmission rate is defined as the ratio of the first vibration value to the second vibration value for each frequency. The vibration analysis module 152 calculates the vibration value transmission rate for each frequency by calculating the ratio of the first vibration value to the second vibration value for each frequency, and calculates the optimal frequency at which the vibration value transmission rate is highest among a plurality of frequencies.

The optimal sound source selection module 153 receives feedback of the optimal frequency from the vibration analysis module 152, and selects an optimal sound source used to generate an excitation signal among at least one sound source based on the optimal frequency. Here, the at least one sound source that is the pool of the optimal sound source selection may be selected by the sound source preprocessing module 151 as described above.

The optimal sound source selection module 153 calculates a difference value between an optimal vibration value corresponding to the optimal frequency among second vibration values and an average vibration value calculated for each of at least one sound source, and selects, as the optimal sound source, a sound source corresponding to an average vibration value at which the difference value is lowest. In other words, among the at least one sound source, a sound source whose average vibration value is closest to the optimal vibration value is selected as the optimal sound source.

In some embodiments, the electronic device 150 may further include the drive module 154.

The drive module 154 drives the hollow-fiber membrane module 140 in one of an internal pressure mode and an external pressure mode. The internal pressure mode is a mode in which the hollow-fiber membrane module 140 operates in the internal pressure type, and the external pressure mode is a mode in which the hollow-fiber membrane module 140 operates in the external pressure type. The hollow-fiber membrane module 140 may be implemented to selectively operate in the internal pressure mode or the external pressure mode.

In the internal pressure mode, the drive module 154 generates a first excitation signal generation instruction corresponding to the optimal frequency and transmits first excitation signal generation instruction to the exciter controller 110. That is, in the setting of the internal pressure mode, the exciter controller 110 generates a first excitation signal corresponding to the optimal frequency and transmits the first excitation signal to the exciter 131. For example, the first excitation signal may be a periodic signal with an optimal frequency.

In the external pressure mode, the drive module 154 generates a second excitation signal generation instruction corresponding to the optimal sound source and transmits the second excitation signal generation instruction to the exciter controller 110. That is, in the setting of the external pressure mode, the exciter controller 110 generates a second excitation signal corresponding to the optimal sound source and transmits the second excitation signal to the exciter 131. For example, the second excitation signal may be an excitation signal corresponding to the optimal sound source as described above.

According to some embodiments, when the drive module 154 is included in the electronic device 150, the electronic device 150 may control an excitation signal to be generated differently depending on the internal/external pressure mode. In this case, in the internal pressure mode, when a membrane fouling reduction effect based on the optimal sound source is lower than a membrane fouling reduction effect based on the optimal frequency, there is the advantage of being able to compensate for this.

According to the hollow-fiber membrane fouling reduction system 100 according to various examples of the present disclosure described above and the electronic device 150 included therein, since it is possible to reduce membrane fouling by generating vibration which is most efficient at reducing fouling without the use of chemicals, it is possible to operate the system at lower pressure than existing systems. In addition, the system is able to be applied without special preprocessing even in a condition in which raw water quality is deteriorated, and thus may be effective against various membrane fouling substances, and may extend the lifespan of a membrane by suppressing membrane fouling.

### Method Related to Hollow-Fiber Membrane Fouling Reduction System

Hereinafter, a method related to the hollow-fiber membrane fouling reduction system 100 performed by the hollow-fiber membrane fouling reduction system 100 or the electronic device 150 described above will be described. Detailed description of parts that overlap with those described above will be omitted.

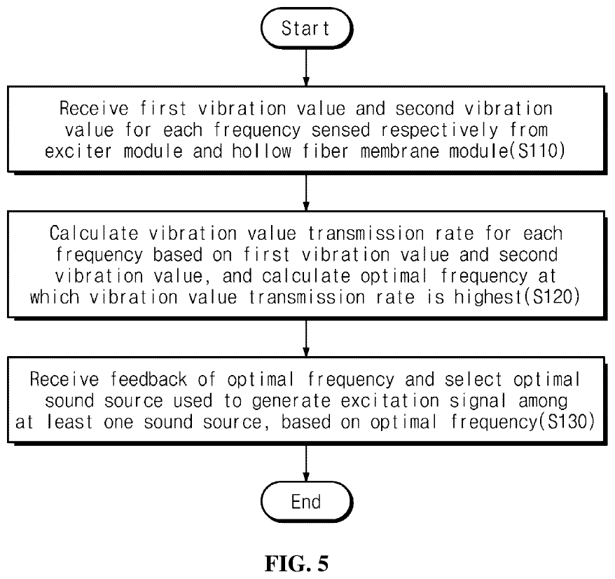

FIG. 5 is a flowchart of a method for controlling a hollow-fiber membrane fouling reduction system 100 according to an example of the present disclosure.

Referring to FIG. 5, in S110, the electronic device 150 receives the first vibration value and the second vibration value for each frequency sensed respectively from the exciter module 130 and the hollow-fiber membrane module 140.

In S120, the electronic device 150 calculates the vibration value transmission rate for each frequency based on the first vibration value and the second vibration value, and calculates an optimal frequency at which the vibration value transmission rate is highest.

In S130, the electronic device 150 receives feedback of the optimal frequency and selects an optimal sound source used to generate an excitation signal among the at least one sound source, based on the optimal frequency.

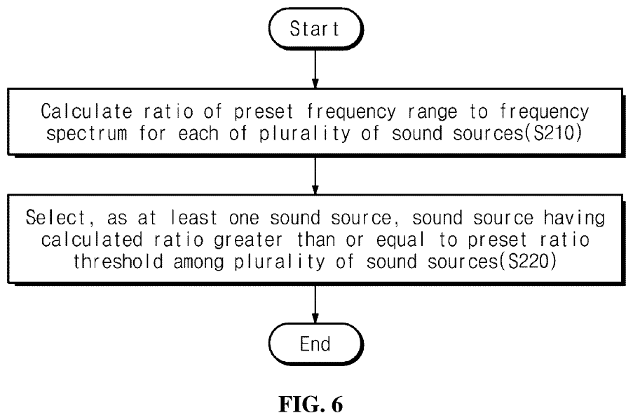

FIG. 6 is a flowchart of a sound source preprocessing method according to an example of the present disclosure.

Referring to FIG. 6, in S210, the electronic device 150 calculates the ratio of a preset frequency range to a frequency spectrum for each of a plurality of sound sources.

In S220, the electronic device 150 selects, as at least one sound source, a sound source having the calculated ratio greater than or equal to the preset ratio threshold among the plurality of sound sources. The selected at least one sound source may be used as a pool for selecting the optimal sound source.

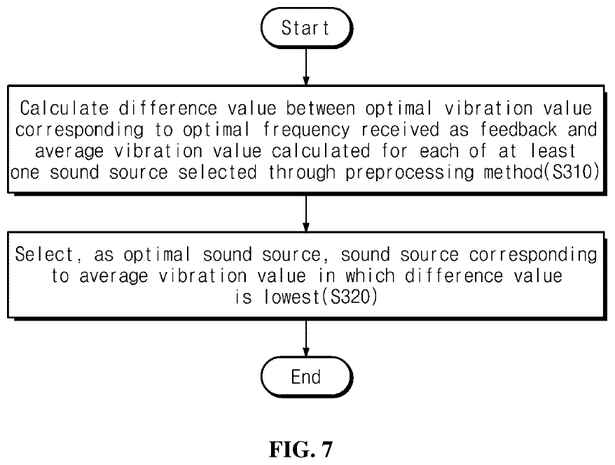

FIG. 7 is a flowchart of an optimal sound source selection method according to an example of the present disclosure.

Referring to FIG. 7, in S310, the electronic device 150 calculates a difference value between the optimal vibration value corresponding to the optimal frequency received as feedback and the average vibration value calculated for each of the at least one sound source selected through the preprocessing method. For example, when the optimal vibration value is defined as fₓ and the average vibration value for each of at least one sound source is defined as fᵢ (wherein i is the index of at least one sound source), the difference value may be defined as |fₓ−fᵢ|.

In S320, the electronic device 150 selects, as the optimal sound source, a sound source corresponding to the average vibration value in which the difference value is lowest.

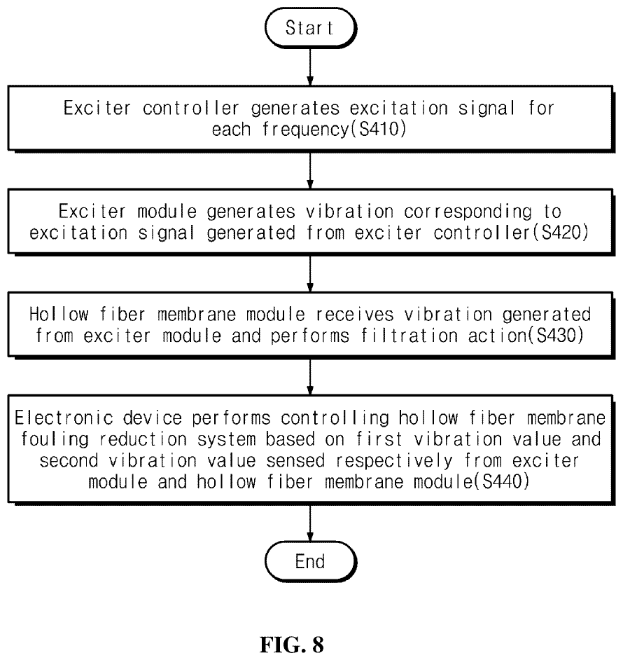

FIG. 8 is a flowchart of the method of reducing the fouling of a hollow-fiber membrane 141 according to an example of the present disclosure.

Referring to FIG. 8, in S410, the exciter controller 110 generates an excitation signal for each frequency.

In S420, the exciter module 130 generates vibration corresponding to the excitation signal generated from the exciter controller 110. Prior to S420, amplifying the excitation signal by the amplification module 120 may be further included, and in this case, the exciter module 130 generates vibration corresponding to the amplified excitation signal.

In S430, the hollow-fiber membrane module 140 receives the vibration generated from the exciter module 130.

In S440, the electronic device 150 performs controlling the hollow-fiber membrane fouling reduction system 100 based on the first vibration value and the second vibration value sensed respectively from the exciter module 130 and the hollow-fiber membrane module 140. For example, the electronic device 150 receives the first vibration value and the second vibration value for each frequency sensed respectively from the exciter module 130 and the hollow-fiber membrane module 140 as described above, calculates the vibration value transmission rate for each frequency based on the first vibration value and the second vibration value, and calculates the optimal frequency at which the vibration value transmission rate is highest. Next, the electronic device 150 receives the optimal frequency as feedback, and selects the optimal sound source used to generate the excitation signal among the at least one sound source based on the optimal frequency.

### Experimental Example

Below, experimental examples based on the various examples of the present disclosure described above will be described. The experimental examples according to the present disclosure are carried out in the hollow-fiber membrane fouling reduction system 100 described above, and specific experimental conditions are shown in Table 1 and Table 2. Table 1 is the experimental conditions for MD, and Table 2 is experimental conditions for MD conditions.

TABLE 1

| Parameter | MD |
|---|---|
| Membrane material | PE(polyethylene) |
| Fiber inner diameter (mm) | 0.57 |
| Fiber outer diameter (mm) | 0.83 |
| Pore size (μm) | 0.1 |
| Porosity rate (%) | 70 |
| Membrane area size per module (cm2) | 65 |

TABLE 2

| Parameter | MD condition |
|---|---|
| Raw water | NaCl 35,000 ppm, CaSO4 2,000 ppm |
| Supply flow rate (L/min) | 0.9 |
| Flow rate (L/min) | 0.6 |
| Supply side temperature (° C.) | 60 |
| Distillation side temperature (° C.) | 20 |
| Mode | Internal pressure type/ |
| | External pressure type |
| Vibration frequency | Continuous, no vibration, random |
| | vibration, sound source (pattern) |

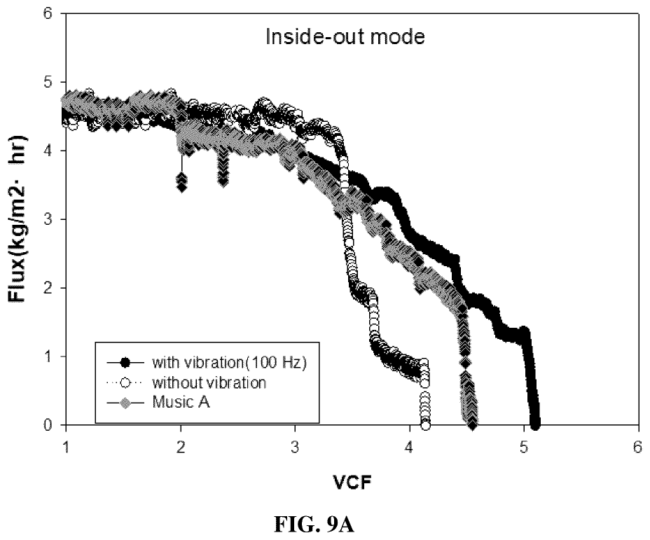

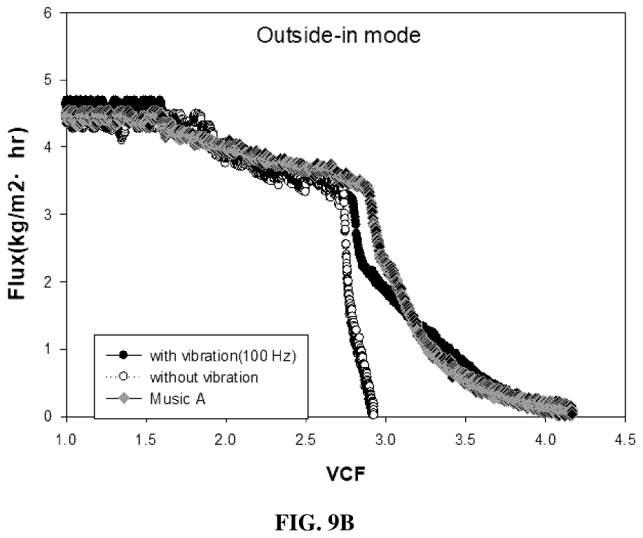

In the vibration frequency of Table 2, “continuous” refers to vibration applied according to a periodic signal corresponding to an optimal frequency selected according to various examples of the present disclosure described above, and “sound source (pattern)” refers to vibration applied according to an excitation signal corresponding to an optimal sound source selected according to various examples of the present disclosure described above. FIGS. 9A and 9B illustrate flux results for VCFs according to experimental examples of the present disclosure. Referring to FIG. 9A, in the MD internal pressure mode of the hollow-fiber membrane 141, even if a VCF value exceeds 4 when vibration according to the optimal sound source and the optimal frequency is applied thereto, compared to non-vibration, a flow rate is guaranteed to some extent, thereby making fouling reduction more effective, and particularly, it may be seen that the optimal frequency is the most effective in reducing fouling.

Referring to FIG. 9B, even in the MD external pressure mode of the hollow-fiber membrane 141, even if a VCF value exceeds 3 when vibration according to the optimal sound source and the optimal frequency is applied thereto, compared to non-vibration, a flow rate is guaranteed to some extent, making fouling reduction more effective, and particularly, it may be seen that the optimal sound source is the most effective in reducing fouling.

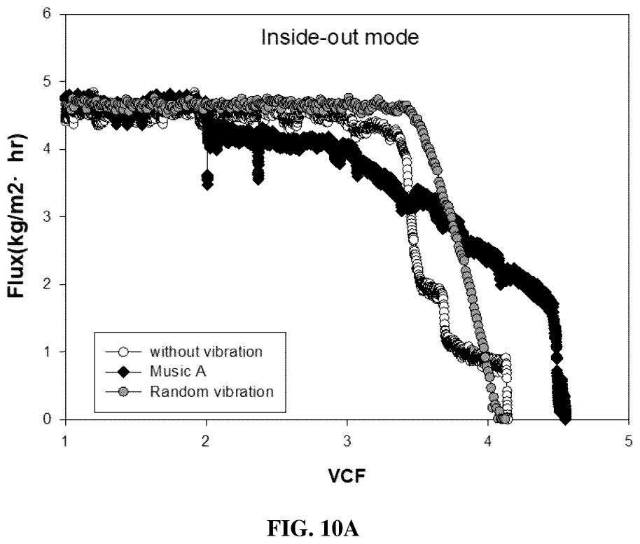

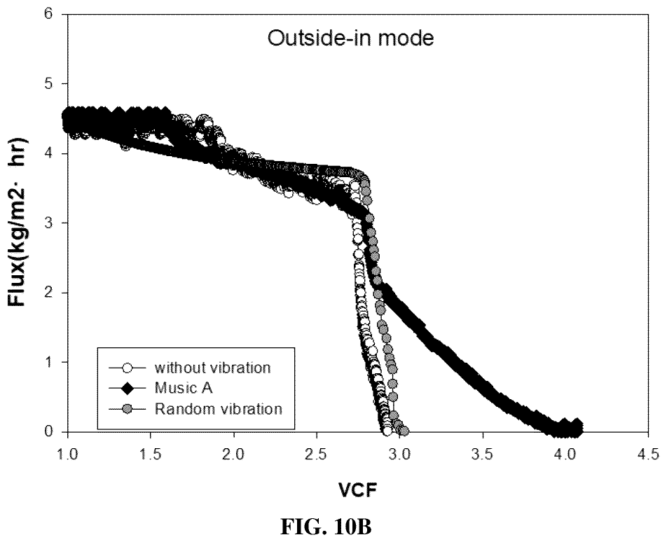

FIGS. 10A and 10B illustrate flux results for VCFs according to another experimental example of the present disclosure.

Referring to FIG. 10A, in the MD internal and external pressure modes of the hollow-fiber membrane 141, it may be seen that the sound source (a pattern), that is, the optimal sound source, is more effective in reducing fouling than the case of no vibration and random vibration. It may be seen that when using the optimal sound source, in the internal pressure mode, a fouling reduction effect is maintained even if a VCF exceeds 4, and in the external pressure mode, a fouling reduction effect is maintained even if a VCF exceeds 3.

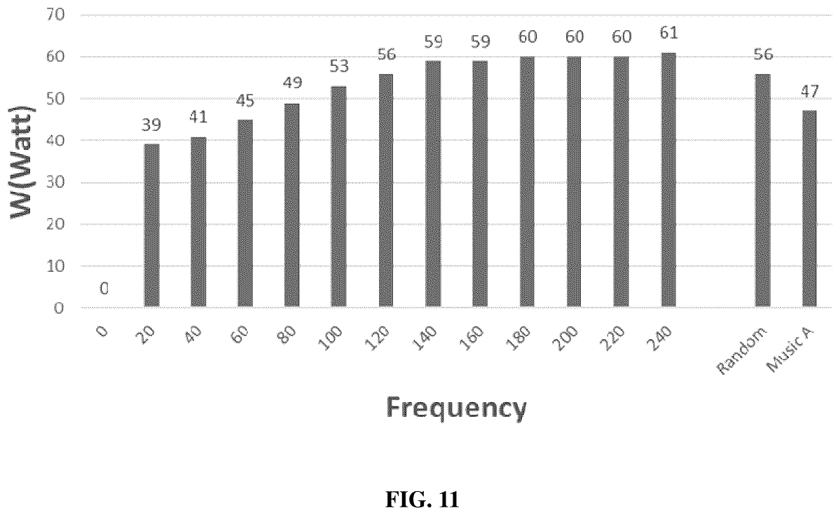

FIG. 11 illustrates the power consumption of vibration generation according to an experimental embodiment of the present disclosure.

Referring to FIG. 11, it may be seen that when using the optimal sound source, there is a power consumption reduction effect of about 10 W compared to the random pattern, and the optimal sound source has a power consumption reduction effect compared to most other frequencies.

As in the above-described experimental examples, according to various examples of the present disclosure, the optimal sound source may be used to effectively reduce fouling of the hollow-fiber membrane 141 and reduce more power consumption than when using vibration according to different frequencies, so it is possible to operate efficiently the hollow-fiber membrane fouling reduction system 100.

It is clear that examples of the proposed method in the above description may also be included as one of the implementation methods of the present disclosure, and thus may be regarded as a type of proposed methods. Additionally, the proposed methods described above may be implemented independently, but may also be implemented in the form of a combination (or merger) of some of the proposed methods.

Examples of the present disclosure disclosed as described above are provided so that those skilled in the art related to the present disclosure are able to implement and practice the present disclosure. Although the description has been made above with reference to examples of the present disclosure, those skilled in the art may modify and change the examples of the present disclosure in various ways. Therefore, the present disclosure is not intended to be limited to the examples shown herein but is to provide the widest scope consistent with the principles and novel features disclosed herein.

1. An electronic device for controlling a hollow-fiber membrane fouling reduction system including an exciter controller configured to generate an excitation signal, an exciter module configured to generate vibration corresponding to the excitation signal by being connected electrically to the exciter controller, and a hollow-fiber membrane module configured to receive the vibration generated from the exciter module, the electronic device comprising:
a vibration analysis module configured to receive first vibration values and second vibration values for frequencies sensed respectively from the exciter module and the hollow-fiber membrane module, calculate a vibration value transmission rate for each frequency based on the first vibration values and the second vibration values, and calculate an optimal frequency at which the vibration value transmission rate is highest; and
an optimal sound source selection module configured to receive feedback of the optimal frequency and select an optimal sound source used to generate the excitation signal among at least one sound source, based on the optimal frequency.

2. The electronic device of claim 1, wherein the vibration value transmission rate is defined as a ratio of the first vibration values to the second vibration values for frequencies.

3. The electronic device of claim 1, wherein the optimal sound source selection module calculates a difference value between an optimal vibration value corresponding to the optimal frequency among the second vibration values and an average vibration value calculated for each of the at least one sound source, and selects, as the optimal sound source, a sound source corresponding to an average vibration value at which the difference value is lowest.

4. The electronic device of claim 3, wherein the electronic device further includes:
a sound source preprocessing module configured to analyze a frequency spectrum of each of a plurality of sound sources and select the at least one sound source among the plurality of sound sources.

5. The electronic device of claim 4, wherein the sound source preprocessing module selects, as the at least one sound source, a sound source in which a ratio of a preset frequency range to the frequency spectrum is greater than or equal to a preset ratio threshold among the plurality of sound sources.

6. The electronic device of claim 1, wherein the electronic device further includes:
a drive module configured to drive the hollow-fiber membrane module in one of an internal pressure mode and an external pressure mode,
wherein the drive module is configured to generate a first excitation signal generation instruction corresponding to the optimal frequency and transmit the first excitation signal generation instruction to the exciter controller in the internal pressure mode, and
to generate a second excitation signal generation instruction corresponding to the optimal sound source and transmit the second excitation signal generation instruction to the exciter controller in the external pressure mode.

7. A hollow-fiber membrane fouling reduction system comprising:
an exciter controller configured to generate an excitation signal;
an exciter module configured to generate vibration corresponding to the excitation signal by being connected electrically to the exciter controller;
a hollow-fiber membrane module configured to receive the vibration generated from the exciter module; and
an electronic device configured to control the exciter controller and the hollow-fiber membrane module,
wherein the electronic device includes:
a vibration analysis module configured to receive first vibration values and second vibration values for frequencies sensed respectively from the exciter module and the hollow-fiber membrane module, calculate a vibration value transmission rate for each frequency based on the first vibration values and the second vibration values, and calculate an optimal frequency at which the vibration value transmission rate is highest; and
an optimal sound source selection module configured to receive feedback of the optimal frequency and select an optimal sound source used to generate the excitation signal among at least one sound source, based on the optimal frequency.

8. The system of claim 7, wherein the optimal sound source selection module calculates a difference value between an optimal vibration value corresponding to the optimal frequency among the second vibration values and an average vibration value calculated for each of the at least one sound source, and selects, as the optimal sound source, a sound source corresponding to an average vibration value at which the difference value is lowest.

9. The system of claim 8, wherein the electronic device further includes:
a sound source preprocessing module configured to analyze a frequency spectrum of each of a plurality of sound sources and select the at least one sound source among the plurality of sound sources,
wherein the sound source preprocessing module selects, as the at least one sound source, a sound source in which a ratio of a preset frequency range to the frequency spectrum is greater than or equal to a preset ratio threshold among the plurality of sound sources.

10. The system of claim 7, wherein the electronic device further includes:
a drive module configured to drive the hollow-fiber membrane module in one of an internal pressure mode and an external pressure mode,
wherein the drive module is configured to generate a first excitation signal generation instruction corresponding to the optimal frequency and transmit the first excitation signal generation instruction to the exciter controller in the internal pressure mode, and
to generate a second excitation signal generation instruction corresponding to the optimal sound source and transmit the second excitation signal generation instruction to the exciter controller in the external pressure mode.

11. The system of claim 7, further comprising:
an amplification module configured to amplify the excitation signal and transmit the excitation signal to the exciter module.

12. The system of claim 11, wherein the exciter module further includes:
an exciter configured to receive the excitation signal and generate vibration corresponding to the excitation signal; and
a first acceleration sensor configured to be electrically connected to the exciter and sense the first vibration values from the vibration of the exciter,
wherein the hollow-fiber membrane module further includes:
a hollow-fiber membrane configured to receive the vibration generated from the exciter and filter raw water based on the vibration; and
a second acceleration sensor configured to be electrically connected to the hollow-fiber membrane and sense the second vibration values from the vibration of the hollow-fiber membrane.

13. A method for controlling a hollow-fiber membrane fouling reduction system performed by an electronic device, the method comprising:
receiving first vibration values and second vibration values for frequencies sensed respectively from an exciter module and a hollow-fiber membrane module;
calculating a vibration value transmission rate for each frequency based on the first vibration values and the second vibration values, and calculating an optimal frequency at which the vibration value transmission rate is highest; and
receiving feedback of the optimal frequency, and selecting an optimal sound source used to generate the excitation signal among at least one sound source based on the optimal frequency.

14. The method of claim 13, wherein the selecting of the optimal sound source further includes:
calculating a difference value between an optimal vibration value corresponding to the optimal frequency among the second vibration values and an average vibration value calculated for each of the at least one sound source; and
selecting, as the optimal sound source, a sound source corresponding to an average vibration value at which the difference value is lowest.

15. The method of claim 14, further comprising:
calculating a ratio of a preset frequency range to a frequency spectrum for each of a plurality of sound sources; and
selecting, as the at least one sound source, a sound source in which the ratio is greater than or equal to a preset ratio threshold among the plurality of sound sources.
